(19) United States
(12) Patent Application Publication
(10) Pub. No.: US 2006/0019606 A1
(43) Pub. Date: Jan. 26, 2006

(54) Multi-channel measurement system and power supplying method for the system

(75) Inventors: Kentaro Hazama, Tokyo (JP); Makoto Ishii, Tokyo (JP); Yukihiro Seki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/080,433

(22) Filed: Mar. 16, 2005

(30) Foreign Application Priority Data
Jul. 21, 2004 (JP) 2004-213080

(51) Int. Cl. H04B 17/00

(52) U.S. Cl. 455/67.11

(57) ABSTRACT

It is intended to realize a multi-channel measurement system and a power supply method for the system, the system being capable of performing maintenance of each of channel units and detectors without interrupting a power supply to the overall system. The multi-channel measurement system having a plurality of channel units each of which has a detector and performs measurement operation using a detection output from the detector and a power unit which supplies power to the channel units is characterized by a plurality of sub-switches respectively provided for the channel units, each of the sub-switches interrupting the power supply to the relevant channel unit, and a control unit for outputting a result of arithmetic processing of measurement outputs from the channel units and controlling the interruptions by the sub-switches.

### BACKGROUND OF THE INVENTION

1. Field of the Invention

The present invention relates to a multi-channel measurement system having a plurality of channel units to each of which a detector is connected and performing arithmetic processing such as an average value calculation of a plurality of measurement outputs as well as a method for supplying power to the system.

More specifically, the invention relates to the multi-channel measurement system which enables to perform maintenance of each of the channel units and the detectors without interrupting a power supply to the overall system and the power supplying method for the system.

2. Description of Prior Art

In a combustion management and control system for a large scale boiler and the like used in a power plant or an iron and steel plant, it is necessary to manage and control the combustion so as to achieve an optimum combustion state by monitoring a furnace oxygen concentration from the view point of environment conservation and energy conservation.

For instance, when the oxygen concentration for burning a fuel is low, an amount of smoke to be generated is increased due to imperfect combustion to lead to environment deterioration. In turn, when the oxygen concentration is excessively high, an amount of fuel to be consumed is increased, and NOx, which is one of air pollution substances, is undesirably generated due to bonding with nitrogen in the air.

The multi-channel measurement system of this invention is suitably applied to an oxygen concentration meter to be used for the above-described purpose.

The oxygen concentration meter measures oxygen concentrations of a plurality of points in the furnace and calculates an average value of the oxygen concentrations to feed back the average value to a combustion control device. The combustion control device controls an air-fuel ratio and the like to optimize the average oxygen concentration in the furnace.

FIG. 1 is a block diagram showing one example of a conventional multi-channel measurement system. Referring to FIG. 1, the multi-channel measurement system has a power unit 1, channel units 21 to 28 independently performing measurement operation, detectors (sensors) 31 to 38 respectively corresponding to the channel units 21 to 28, a control unit 4 which receives measurement outputs from the channel units 21 to 28 and performs processing for calculating an average value of the measurement outputs, and a display unit 41 for displaying measurement values. The multi-channel measurement system shown in FIG. 1 has 8 measurement points.

As shown in FIG. 1, the channel unit 21 and the detector 31 constitute an independent measurement device (measurement unit), and the channel unit 22 to 28 and the detectors 32 to 38 constitute measurement devices (measurement units) in the same manner, so that the system has 8 measurement devices (measurement units) in total.

Also, as shown in FIG. 1, power is supplied to the channel units 21 to 28 and the control unit 4 from the power unit 1, and a main switch S0 performs on/off of the power supply.

The measurement outputs from the channel units 21 to 28 are input to the control unit 4 so that the average value of the 8 points and the like are calculated. Also, the calculation output is fed back to a controller and the like. Examples of the output from the control unit include, in addition to the average value, a contact output to be used for warning operation.

The display unit 41 displays the measurement values of the measurement points, the average value obtained by the calculation, and the like.

[Patent Literature 1] JP-A-11-030581

However, in the conventional system described above, it is necessary to interrupt the power supply to the overall system in order to repair the channel units 21 to 28 or to perform replacement and maintenance of the detectors 31 and 38.

Therefore, in the case of performing the maintenance of one of the detectors, it is necessary to cut off the power supply for the channels which are not the object for the maintenance, and it is impossible to perform the measurements during the maintenance.

Particularly, in a measurement device requiring a long time for warming up a detector (zirconia sensor), such as a zirconia oxygen concentration meter, a long period of time is required for restarting the measurement after cutting off the power, thereby remarkably decreasing an operation rate of the system.

An object of this invention is to eliminate the above-described drawbacks of the conventional system and to realize a multi-channel measurement system and a power supply method for the system, the system enabling to perform maintenance of each of channel units and detectors without interrupting a power supply to the overall system.

### SUMMARY OF THE INVENTION

In order to attain the above object, a multi-channel measurement system according to one aspect of this invention comprises a plurality of channel units each of which has a detector and performs measurement operation using a detection output from the detector and a power unit for supplying power to the channel units, the multi-channel measurement system further comprising a plurality of sub-switches respectively provided for the channel units, each of the sub-switches interrupting the power supply to the relevant channel unit, and a control unit for outputting a result of arithmetic processing of measurement outputs from the channel units and controlling the interruptions by the sub-switches.

The multi-channel measurement system is characterized in that the control unit comprises a touch panel type display unit and controls the interruptions by the sub-switches in response to operation of the touch panel.

The multi-channel measurement system is characterized in that the control unit performs the arithmetic processing of the measurement outputs except for the measurement output from the channel unit for which the power supply is interrupted.

The multi-channel measurement system is characterized in that the arithmetic processing in the control unit is an average value calculation.

According to another aspect of this invention, there is provided a method for supplying power to a multi-channel measurement system comprising a plurality of channel units each of which has a detector and performs measurement operation using a detection output from the detector and a power unit which supplies power to the channel units, the power supply method comprising interrupting the respective power supplies to the channel units by the use of a plurality of sub-switches respectively provided for the channel units and controlling the interruptions by the sub-switches by the use of a control unit for outputting a result of arithmetic processing of measurement outputs from the channel units.

The power supply method is characterized in that the control unit comprises a touch panel type display unit and controls the interruptions by the sub-switches in response to operation of the touch panel.

The power supply method is characterized in that the control unit performs the arithmetic processing of the measurement outputs except for the measurement output from the channel unit for which the power supply is interrupted.

The power supply method is characterized in that the arithmetic processing in the control unit is an average value calculation.

It is possible to realize the multi-channel measurement system which enables to perform maintenance of each of the channel units and the detectors without interrupting a power supply to the overall system by the use of the sub-switches for independently interrupting the power supplies to the channel units and by controlling the interruptions by the sub-switches by the use of the control unit for arithmetically processing the measurement outputs from the channel units to output the result of the arithmetic processing.

Thus, the channel units which are not the object for the maintenance continue the measurement operation, and a maintenance work of the channel unit and the detector does not decrease an operation rate of the overall system.

Also, it is possible to ignore an measurement output whose value has become 0 or indeterminate due to the maintenance work and to prevent an erroneous operation result in the average value calculation, by performing the arithmetic operation of the measurement outputs other than the measurement output from the channel unit for which the power supply has been interrupted.

### BRIEF DESCRIPTION OF THE DRAWINGS

FIG. 1 is a block diagram showing one example of a conventional multi-channel measurement system.

FIG. 2 is a block diagram showing one embodiment of a multi-channel measurement system and a power supply method for the multi-channel measurement system of this invention.

FIG. 3 is a diagram showing one example of a display screen of a display unit 5.

FIG. 4 is a diagram showing a display image in the case of a power control mode.

FIG. 5 is a diagram showing another example of a display screen of the display unit 5.

### DESCRIPTION OF THE PREFERRED EMBODIMENTS

Hereinafter, a multi-channel measurement system and a method for supplying power to the system of the present invention will be described with reference to the drawings.

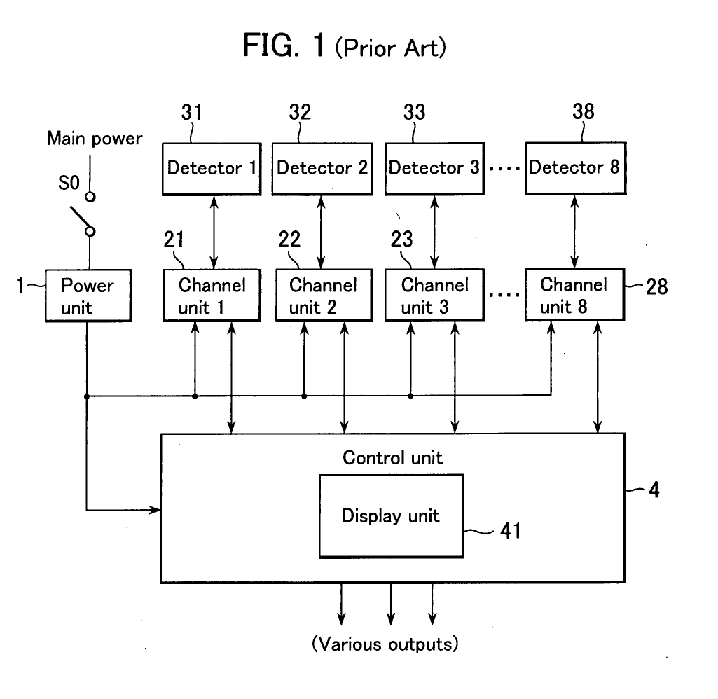

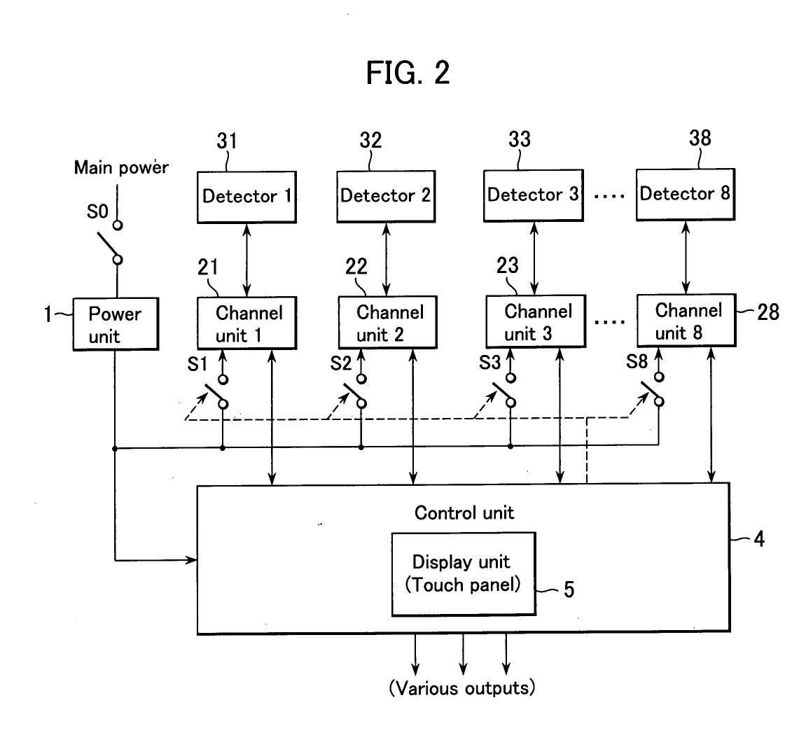

FIG. 2 is a block diagram showing one embodiment of the multi-channel measurement system and the method for supplying power to the system. Among components shown in FIG. 2, those similar to the components shown in FIG. 1 are denoted by the same reference numerals. Sub-switches S1 to S8 are respectively provided for channel units 21 to 28. Each of the sub-switches S1 to S8 is used for interrupting a power supply to the relevant channel unit, and the interruptions are controlled by a control unit 4. A display unit 5 has an input unit such as a touch panel and is used for displaying measurement values and the like, inputting various setting information in the measurement system, and controlling the power supplies to the channel units 21 to 28.

When a main switch S0 is turned on to start operation of the system, the control unit 4 turns on the sub-switches S1 to S8 to supply power to the channel units 21 to 28. In the control unit 4, settings for default of the sub-switches S1 to S8 are ordinarily “ON”.

Then, the channel units 21 to 28 start measurement operation, and measurement outputs from the channel units 21 to 28 are input to the control unit 4. The control unit 4 performs arithmetic processing such as an average value calculation based on the measurement outputs.

Other examples of the arithmetic processing in the control unit 4 than the average value calculation are extraction of maximum measurement output, display of trend graph, generation of warming output, and so forth.

Power control operation involved in a maintenance work of the channel units 21 to 28 and detectors 31 to 38 is described below.

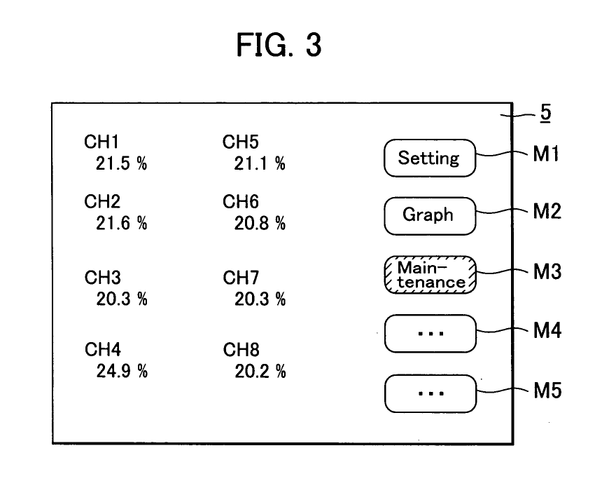

FIG. 3 is a diagram showing one example of a display screen of the display unit 5. Shown in FIG. 3 is the case in which the multi-channel measurement system is applied to an oxygen concentration meter. Referring to FIG. 3, measurement values of oxygen concentrations at the measurement points (CH1 to CH8) and operation keys (software keys) M1 to M5 are displayed on a screen.

In the case of starting a maintenance work of the channel units 21 to 28 or the detectors 31 to 38, a user presses the maintenance key (M3) on the screen and selects a power control mode from an operation menu (not shown).

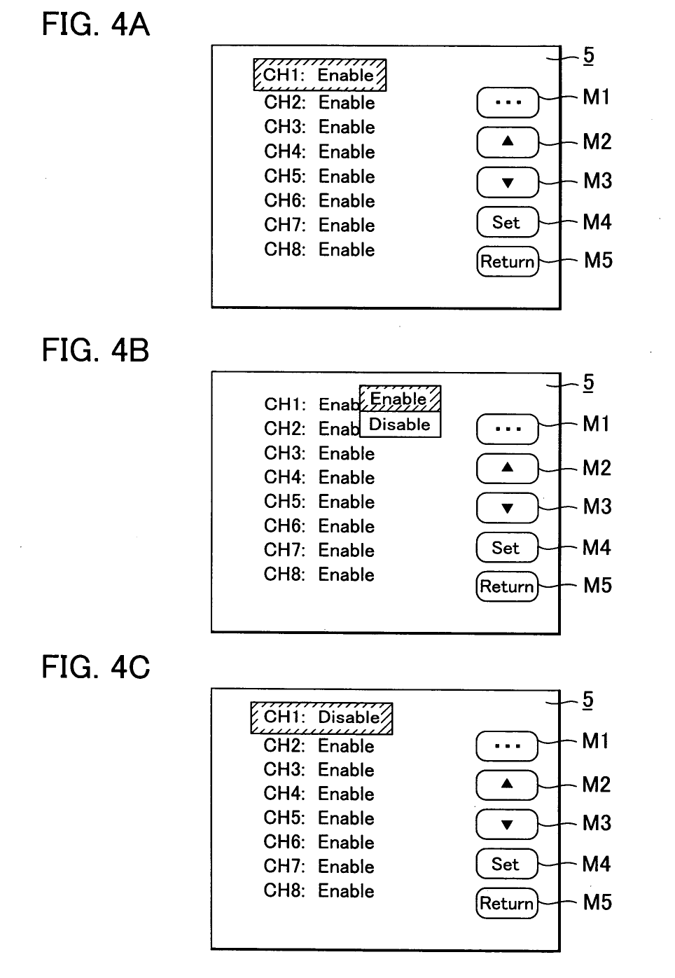

FIG. 4 is a diagram showing a display screen in the power control mode. In FIG. 4A, a power state of each of the channel units 21 to 28 (CH1 to CH8) is “Enable”.

In the case where the maintenance work is to be performed on the channel unit 21 (CH1), the user selects “CH1” (FIG. 4A) by operating the selection keys (M2 and M3) and then presses the set key (M4).

In response to the above operation, “Enable” and “Disable” are displayed on the screen (FIG. 4B). After that, the user selects “Disable” and then presses the set key (M4).

As a result, a setting for the power state of the channel unit 21 (CH1) is changed to “Disable” as shown in FIG. 4C.

Here, the control unit 4 turns off the sub-switch S1 to interrupt the power supply to the channel unit 21 (CH1).

Thus, only the power supply to the channel unit 21 (CH1) is interrupted, and it is possible to perform the maintenance work of the channel unit 21 (CH1) while the other channel units 22 to 28 (CH2 to CH8) continue the measurement operation.

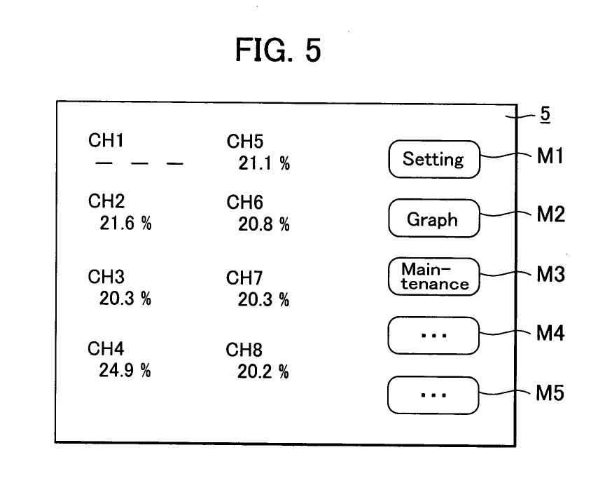

Here, the measurement values displayed on the screen are changed to those shown in FIG. 5 to indicate that the channel unit 21 (CH1) is under suspension.

The change to the screen of FIG. 5 is realized by pressing the return key (M5) on the screen shown in FIG. 4C.

Also, in this state, the control unit 4 carries out the average value calculation by using only the measurement outputs from the channel units 22 to 28 (CH2 to CH8).

Thus, even when the measurement output from the channel unit 21 (CH1) becomes 0 or indeterminate due to the maintenance work, the average value calculation is not influenced by the measurement output from the channel unit 21 (CH1), and it is possible to continue the measurement operation (average value calculation) by the use only of the channel units 22 to 28 which are not the objects for the maintenance.

In the case of restarting the measurement operation of the channel unit 21 (CH1) after finishing the maintenance work, the setting for the power state of the channel unit 21 (CH1) is changed to “Enable” in accordance with the process shown in FIG. 4.

In response to the change, the control unit 4 turns on the sub-switch S1 to restart the power supply to the channel unit 21 (CH1).

The measurement operation by the channel unit 21 (CH1) is restarted with the start of the power supply to the channel unit 21. However, in the case of a zirconia oxygen concentration meter which requires warming-up (heating) of a detector (zirconia sensor), the measurement operation is restarted after the completion of the warming-up.

After the channel unit 21 (CH1) restarts the measurement operation, the control unit 4 displays a measurement value and changes the object for the average value calculation to the measurement outputs from all the channel units 21 to 28 (CH1 to CH8).

Though the case of using the touch panel (dislay unit 5) as the means for inputting the power management information to the control unit 4 is described in the foregoing, the input means is not limited thereto, and it is possible to use a pointing device such as a mouse.

Also, the screen pages on the display unit 5 are not limited to those shown in the drawings, and it is possible to employ an arbitrary constitution.

Though the number of the channel units connected to the control unit 4 is 8 in the foregoing description, the number of measurement points is not limited thereto.

What is claimed is:

1. A multi-channel measurement system comprising:
a plurality of channel units each of which has a detector and performs measurement operation using a detection output from the detector and
a power unit which supplies power to the channel units, wherein
the multi-channel measurement system further comprising:
a plurality of sub-switches respectively provided for the channel units, each of the sub-switches interrupting the power supply to the relevant channel unit, and
a control unit for outputting a result of arithmetic processing of measurement outputs from the channel units and controlling the interruptions by the sub-switches.

2. The multi-channel measurement system according to claim 1, wherein the control unit comprises a touch panel type display unit and controls the interruptions by the sub-switches in response to operation of the touch panel.

3. The multi-channel measurement system according to claim 1 or 2, wherein the control unit performs the arithmetic processing of the measurement outputs except for the measurement output from the channel unit for which the power supply is interrupted.

4. The multi-channel measurement system according to claim 3, wherein the arithmetic processing in the control unit is an average value calculation.

5. A method for supplying power to a multi-channel measurement system comprising a plurality of channel units each of which has a detector and performs measurement operation using a detection output from the detector and a power unit which supplies power to the channel units, wherein
the power supply method comprising:
interrupting the respective power supplies to the channel units by the use of a plurality of sub-switches respectively provided for the channel units and
controlling the interruptions by the sub-switches by the use of a control unit for outputting a result of arithmetic processing of measurement outputs from the channel units.

6. The power supply method according to claim 5, wherein the control unit comprises a touch panel type display unit and controls the interruptions by the sub-switches in response to operation of the touch panel.

7. The power supply method according to claim 5 or 6, wherein the control unit performs the arithmetic processing of the measurement outputs except for the measurement output from the channel unit for which the power supply is interrupted.

8. The power supply method according to claim 7, wherein the arithmetic processing in the control unit is an average value calculation.
